(19) United States
(12) Patent Application Publication
(10) Pub. No.: US 2008/0118193 A1
(43) Pub. Date: May 22, 2008

(54) Roller Circulating Device for a Linear Guideway

(76) Inventors: Tsung-Jen CHEN, Taichung (TW); Yu-Wen Tsai, Taichung (TW)

Correspondence Address: Dr. BANGER SHIA, 102 Lindencrest Ct., Sugar Land, TX, 77479-5201, US

(21) Appl. No.: 11/562,381

(22) Filed: Nov. 21, 2006

(51) Int. Cl. F16C 29/06

(52) U.S. Cl. 384/44

(57) ABSTRACT

A roller circulating device for a linear guideway is formed with a plurality of grooves for enabling a plurality of rollers to circulate therein. The roller circulating device is characterized in that: the respective return paths are connected to the forward path through a tapered surface. And along a direction of a radial surface of the respective rollers, the tapered surface is tapered from the respective return paths to the forward path, thus preventing the rollers from tilting and being jammed, so that the rollers can circulate smoothly.

### BACKGROUND OF THE INVENTION

1. Field of the Invention

The present invention relates to a roller circulating device for a linear guideway, and more particularly to a roller circulating device for a linear guideway, which can enable the rollers to release pressure when passing through the return path, so as to prolong the fatigue life of the rollers.

2. Description of the Prior Art

A conventional linear guideway as shown in FIGS. 1 and 2 generally comprises: a rail 11, a slide block 12, two end caps 13 fixed at both ends of the slide block 12, and a plurality of rollers 14. In the slide block 12 and the end caps 13 is formed a plurality of grooves 15 for enabling the rollers to circulate. It is to be noted that, as shown in FIG. 3, each of the grooves 15 includes a forward path 151, a backward path 152, and two return paths 153. With reference to FIG. 4, the width d1 of the respective return paths 153 is larger than the width d2 of the backward path 152. To prevent the rollers 14 from impacting the entrance and exit 121 of the slide block 12 and causing resistance and noise, a chamfer 122 is formed at either end of the respective grooves 15 of the slide block 12 (as shown in FIG. 5), namely, forming an angle θ with respect to the horizontal level. It seems a good solution at first, but it doesn't work well. The design of the chamfer 122 will produce the following disadvantages: a) increasing the processing cost of the slide block 12 b) reducing the load carrying area of the slide block 12, accordingly, decreasing the rated power and service life of the linear guideway. C), the problem caused by the axial impact of the respective roller 14 has not been solved yet. In addition, as shown in FIG. 5, once the length of the chamber 122 at both ends of the respective grooves 15 of the slide block 12 is larger than the diameter of the respective rollers 14, the abovementioned problems will occur again.

The present invention has arisen to mitigate and/or obviate the afore-described disadvantages.

### SUMMARY OF THE INVENTION

The primary objective of the present invention is to provide a roller circulating device for a linear guideway. Each of the connecting portions between the forward path and the respective return paths is formed with a tapered surface, so as to prevent the rollers from impacting the entrance and exit of the grooves of the slide block, and to prevent the rollers from tilting and being jammed, so that the rollers can circulate smoothly.

The secondary objective of the present invention is to provide a roller circulating device for a linear guideway, wherein the slide block doesn't need any extra chamfer, therefore, the production cost is relatively reduced.

Yet another objective of the present invention is to provide a roller circulating device for a linear guideway, wherein the slide block doesn't need extra chamfer, and the load carrying area of the slide block is not reduced. Therefore, the roller circulating device for a linear guideway of the present invention has a relatively large load carrying capacity and a relatively long service life.

### BRIEF DESCRIPTION OF THE DRAWINGS

FIG. 1 is an assembly view of a conventional linear guideway;

FIG. 2 is a cross sectional view taken along the line 2-2 of FIG. 1;

FIG. 3 is a cross sectional view taken along the line 3-3 of FIG. 2;

FIG. 4 is an enlarged view of the connecting portion between the conventional return path and the forward path;

FIG. 5 is an enlarged view of showing that the length of the chamfer is longer than the diameter of the roller;

FIG. 6 is a cross sectional view of the linear guideway of the present invention take along the line 6-6 of FIG. 2;

FIG. 7A is an enlarged view in accordance with the present invention of showing the connecting portion between the left return path and the radial surface of the forward path;

FIG. 7B is an enlarged view in accordance with the present invention of showing the connecting portion between the right return path and the radial surface of the forward path;

FIG. 8 is a cross sectional view of the linear guideway of the present invention taken along the line 8-8 of FIG. 2;

FIG. 9A is an enlarged view in accordance with the present invention of showing the connecting portion between the left return path and the axial surface of the forward path;

FIG. 9B is an enlarged view in accordance with the present invention of showing the connecting portion between the right return path and the axial surface of the forward path;

FIG. 10A is a coordinate graph of showing the resistance of a conventional linear guideway without tapered surface;

FIG. 10B is a coordinate graph of showing the resistance of the linear guideway in accordance with the present invention, wherein the tapered surface is formed in the direction of the radial surface of the rollers only;

FIG. 10C is a coordinate graph of showing the resistance of the linear guideway in accordance with the present invention, wherein the tapered surface is formed in the direction of the axial surface of the rollers only;

FIG. 10D is a coordinate graph of showing the resistance of the linear guideway in accordance with the present invention, wherein the tapered surfaces are formed both in the direction of the radial surface and in the direction of the axial surface of the rollers;

FIG. 11A is a coordinate graph of showing the comparison of rated dynamic load capacity between the conventional structure and the present invention;

FIG. 11B is a coordinate graph of showing the difference of the life between the conventional structure and the present invention; and

FIG. 11C is a coordinate graph of showing the comparison of rated static load capacity between the conventional structure and the present invention.

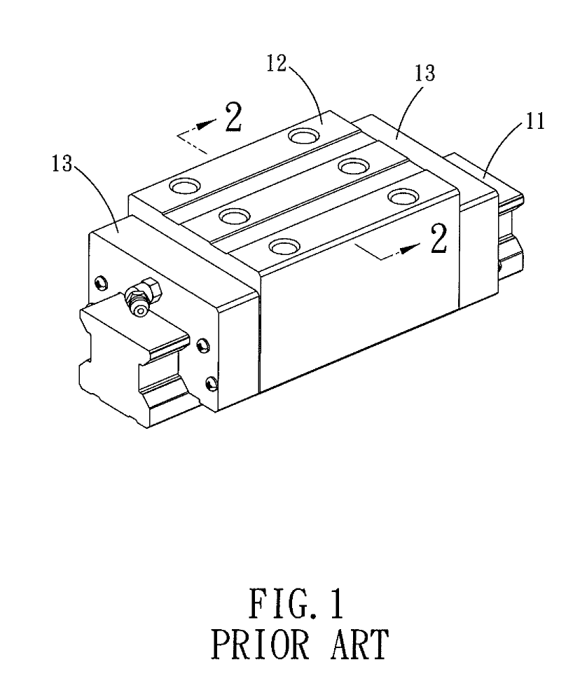

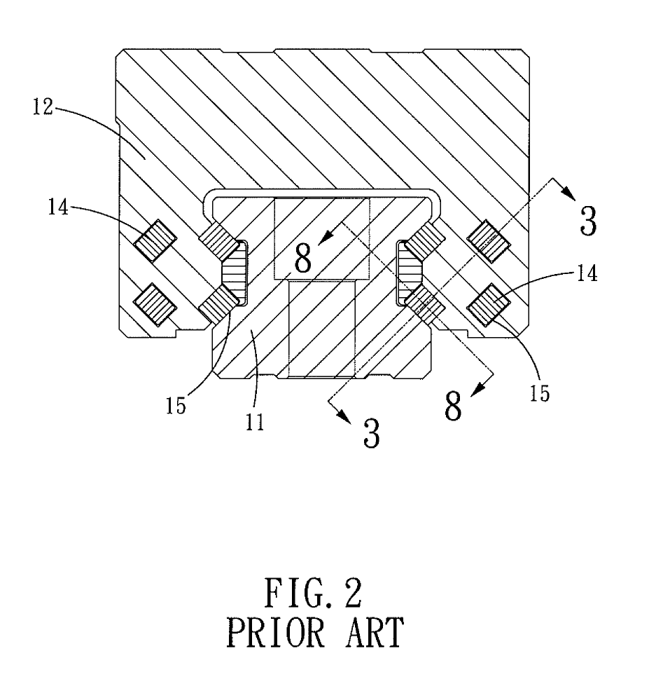

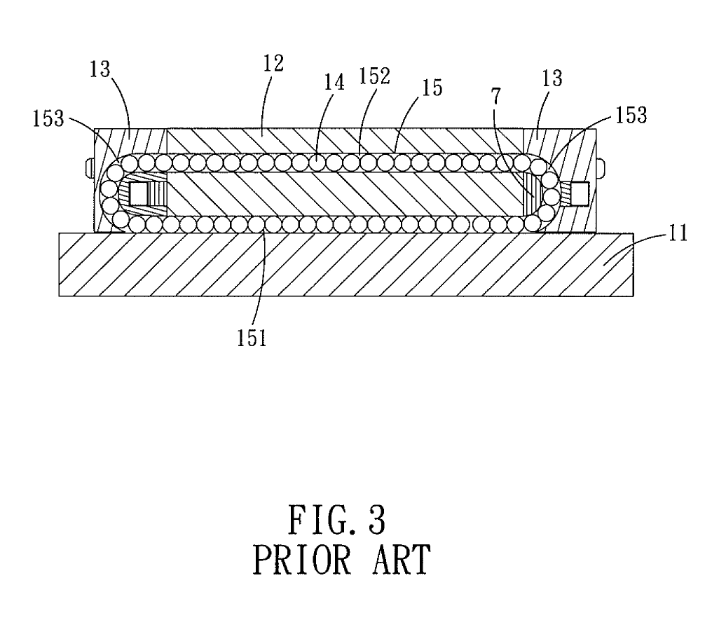

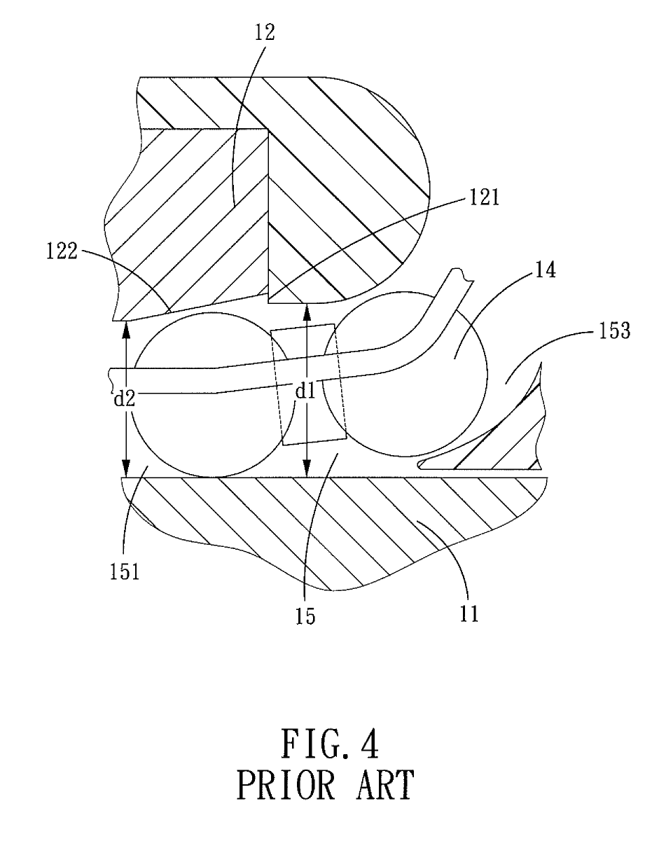

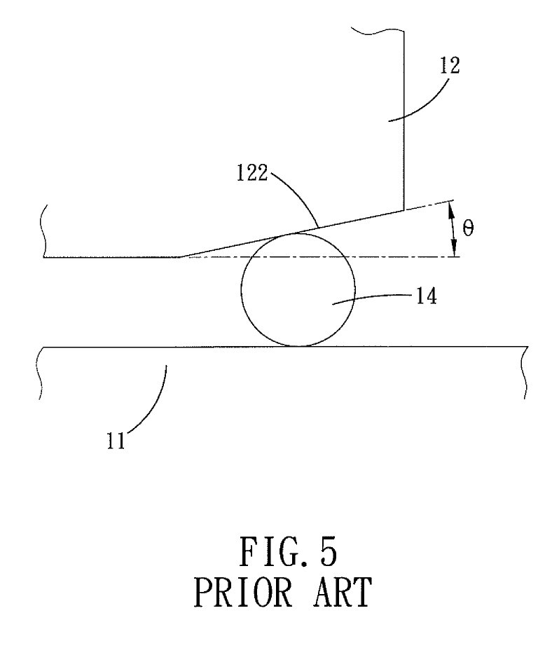

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

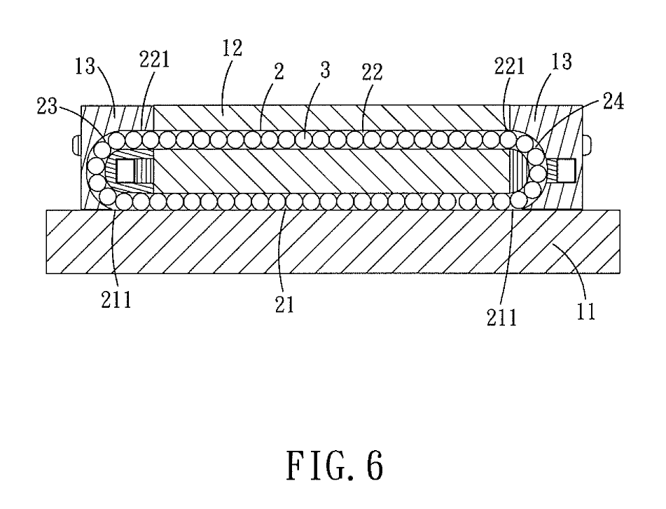

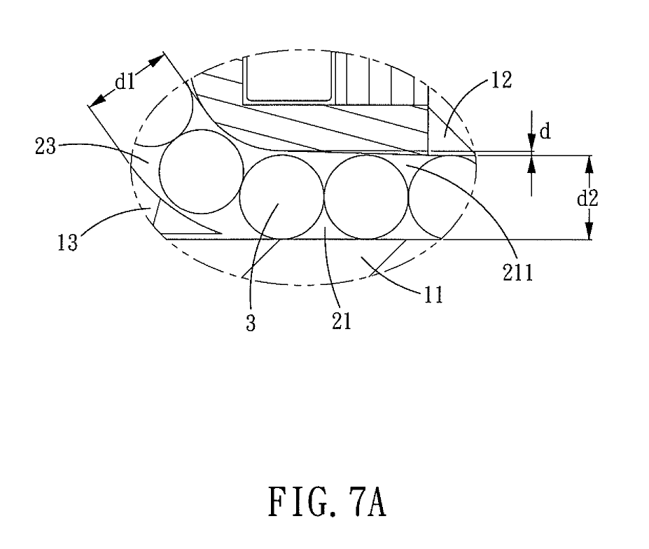

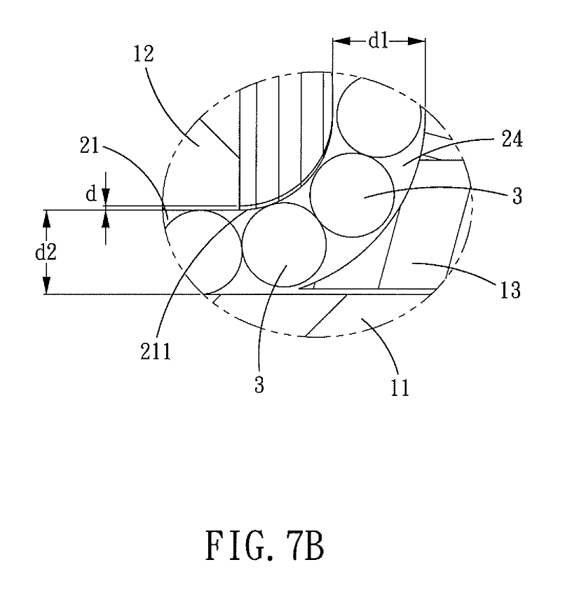

Referring to FIGS. 6, 7A and 7B, a roller circulating device for a linear guideway in accordance with a preferred embodiment of the present invention is formed with a plurality of grooves 2 for enabling a plurality of rollers 3 to circulate therein. Each of the grooves 2 includes a forward path 21, a backward path 22, and two return paths 23 and 24. Two ends of the return path 23 are connected to the forward path 21 and one end of the backward path 22, respectively. And two ends of the return path 24 are connected to the forward path 21 and the other end of the backward path 22. The abovementioned structures are the same as the conventional art, so further explanations will be omitted.

The present invention is characterized in that: as shown in FIGS. 7A and 7B, the first embodiment of the present invention, the respective return paths 23, 24 are connected to the forward path 21 through a tapered surface 211 (both the upper and the lower connecting portions between the forward path 21 and the return paths 23, 24 can be formed with a tapered surface). As an example in this embodiment, only the upper connecting portion between the forward path 21 and the return paths 23, 24 is formed with a tapered surface 211. Along the direction of the radial surface of the respective rollers 3, the tapered surface 211 is tapered from the return paths 23, 24 to the forward path 21; in other words, the path is tapered gradually.

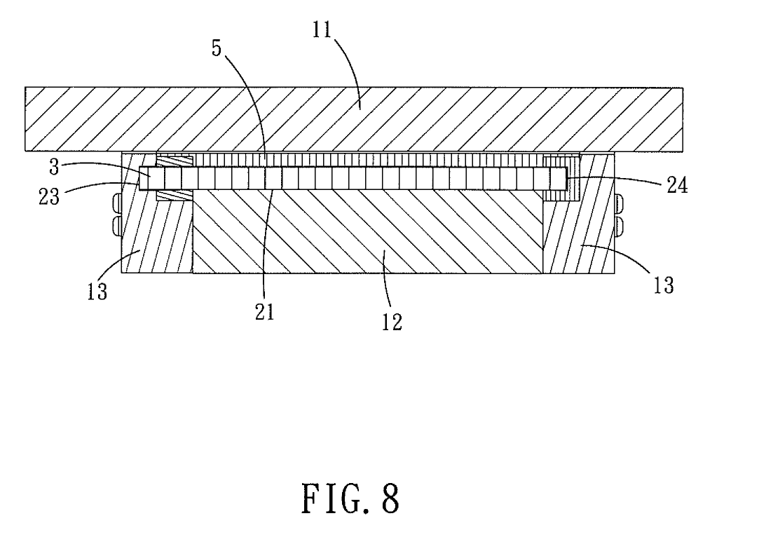

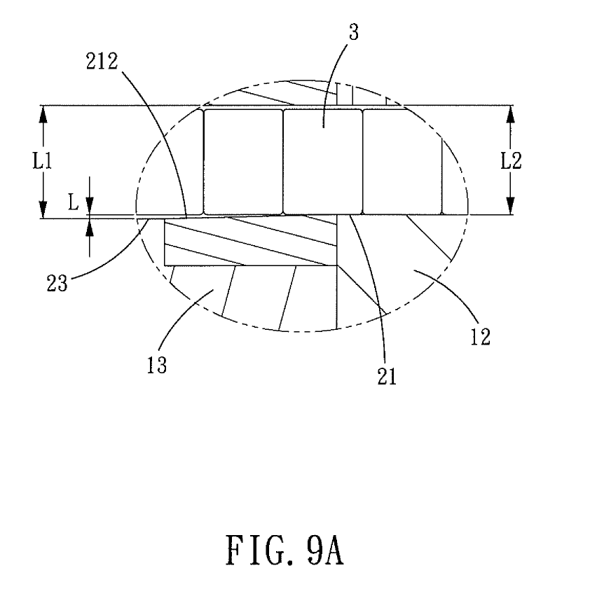

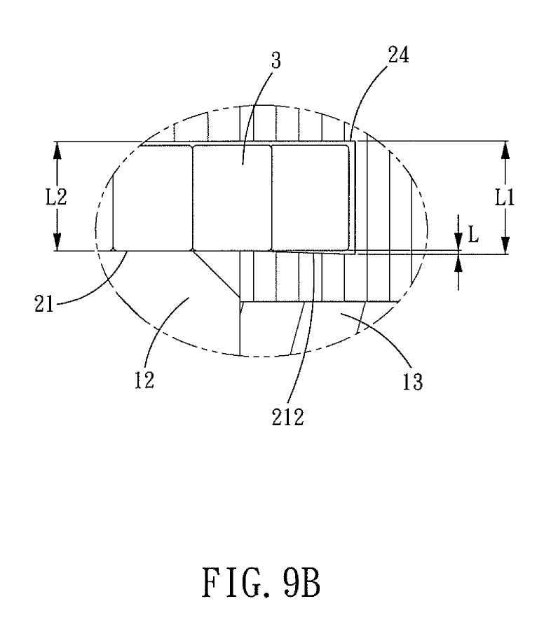

Referring to FIGS. 8, 9A and 9B, a second embodiment of the present invention is shown. The return paths 23 and 24 are connected to the forward path 21 through a tapered surface 212 (both the left and right connecting portions between the forward path 21 and the return paths 23, 24 can be formed with a tapered surface). As an example in this embodiment, only one of the connecting portions between the forward path 21 and the return paths 23, 24 is formed with a tapered surface 211. Along the direction of the axial surface of the respective rollers 3, the tapered surface 211 is tapered from the return paths 23, 24 to the forward path 21; in other words, the path is tapered gradually.

In addition, to enable the rollers 3 to circulate more smoothly, according to the third embodiment of the present invention, both along the direction of the axial surface and the radial surface of the respective rollers 3, the return paths 23 and 24 can be connected to the forward path 21 through the tapered surfaces 211 and 212, (each of the upper and lower connecting portions, and the left and right connecting portions between the forward path 21 and the return paths 23, 24 can be formed with a tapered surface, respectively). In other words, the tapered surfaces 211, 212 are tapered from the return paths 23, 24 to the radial surface and the axial surface of the forward path 21, respectively. By such arrangements, less resistance and noise will be produced during the circulation of the rollers 3.

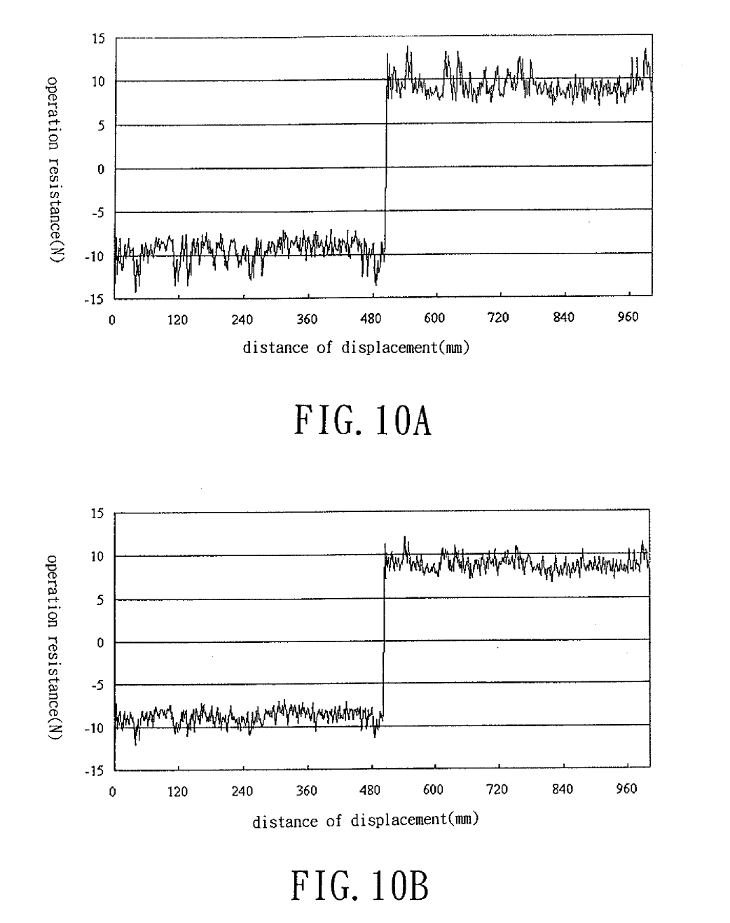

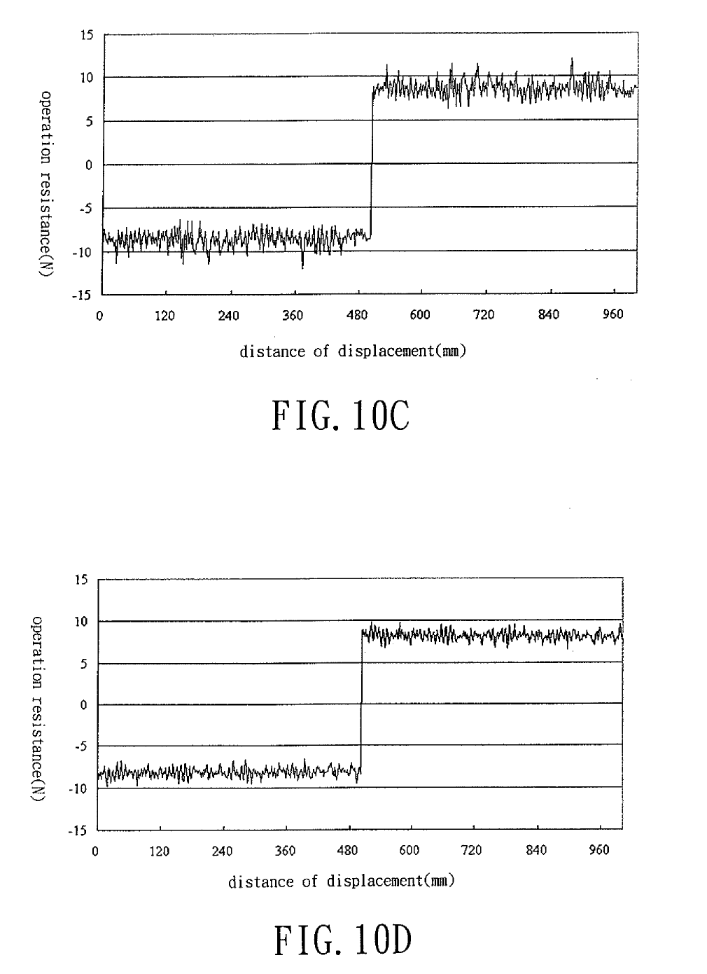

Referring to FIGS. 10a-10d, which show the comparison of the experimental results (the sliding friction resistance) between the roller circulating device of the present invention and the conventional structure. To enable the rollers 3 to release the pressure when passing through the return path and to prolong the fatigue life of the rollers, the radial width d1 of the return paths 23 and 24 is designed to be larger than the radial width d2 of the forward path 21, and they satisfy the relation: d1−d2=d (as shown in FIGS. 7A and 7B). And the axial width L1 of the return paths 23 and 24 is larger than the axial width L2 of the forward path 21, and they satisfy the relation: L1−L2=L (as shown in FIGS. 9A and 9B). FIG. 10A shows the resistance of the conventional linear guideway without the tapered surface. FIG. 10B shows the resistance of the linear guideway in accordance with the present invention, wherein the tapered surface is formed in the direction of the radial surface of the rollers 3 only (the difference of the widths is: d1−d2>=0). FIG. 10C shows the resistance of the linear guideway in accordance with the present invention, wherein the tapered surface is formed in the direction of the axial surface of the rollers 3 only (the difference of the widths is: L1−L2>=0). FIG. 10D shows the resistance of the linear guideway in accordance with the present invention, wherein the tapered surfaces are formed both in the direction of the radial surface (the difference of the widths is: d1−d2>=0) and the axial surface (the difference of the widths is: L1−L2>=0) of the rollers 3. It is understood from FIGS. 10A-10D that the linear guideway can obtain the minimum resistance when all the connecting portions between the return paths, the forward path and the backward path are formed with radial tapered surface 211 and axial tapered surface 212, and thus the roller can circulate smoothly.

In addition, when the radial width d1 of the return paths 23 and 24 is larger than or equal to the radial path d2 of the forward path 21, the width of the tapered surface 221 of the return paths 23 and 24 is smaller than the radial width of the backward path 22. Or, when the axial width L1 of the return paths 23 and 24 is larger than or equal to the axial path L2 of the forward path 21, the width of the tapered surface of the return paths 23 and 24 is smaller than the radial width of the backward path 22. Or both of the abovementioned conditions coexist.

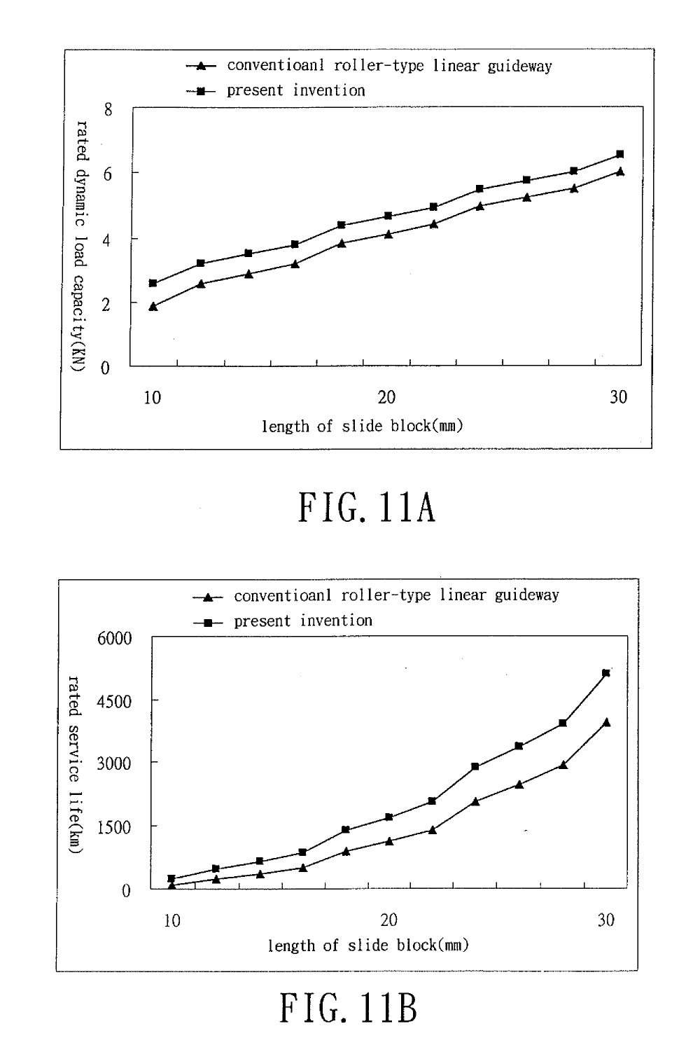

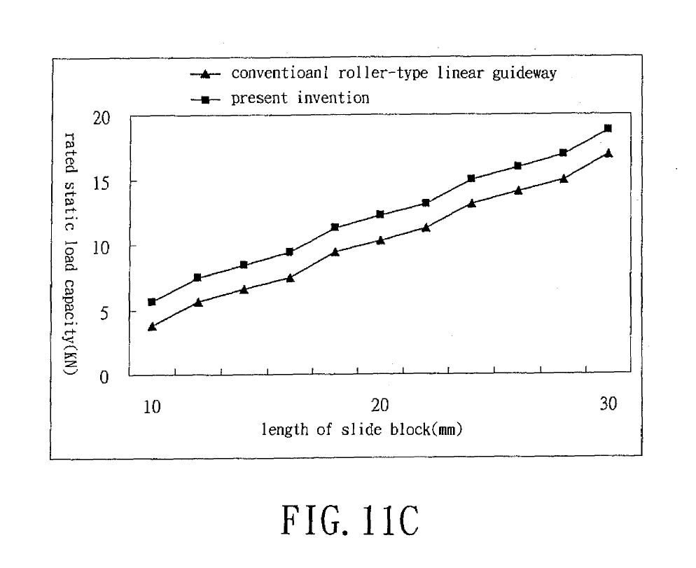

The rated dynamic load capacity of the linear guideway is set based on the ISO 14728-1, which is used to evaluate the rated life of the linear guideway. For example, suppose that the angle of the rollers with respect to the slide block and the rail is 45°, the rollers are 1.5 mm in diameter and 2 mm in length. The comparison of rated dynamic load capacity between the conventional structure and the present invention can be seen from FIG. 11A (the length of the chamfer of the slide block is approximately equal to the diameter of the roller). FIG. 11B shows the difference of the life between the conventional structure and the present invention (the length of the chamfer of the slide block is approximately equal to the diameter of the roller). It is understood from FIG. 11B that the slide block of the present invention doesn't need extra chamfer, and the load carrying area of the slide block is not reduced. Therefore, the roller circulating device for a linear guideway of the present invention has a relatively long service life.

The rated static load capacity of the linear guideway is set based on the ISO 14728-2, which is used to evaluate the rated life of the linear guideway. For example, suppose that the angle of the rollers with respect to the slide block and the rail is 45°, the rollers are 1.5 mm in diameter and 2 mm in length. FIG. 11C shows the comparison of rated static load capacity between the conventional structure and the present invention (the length of the chamfer of the slide block is approximately equal to the diameter of the roller). It is understood from FIG. 11C that the slide block of the present invention doesn't need extra chamfer, and the load carrying area of the slide block is not reduced. Therefore, the roller circulating device for a linear guideway of the present invention has a relatively large load capability.

To summarize, each of the connecting portions between the forward path and the respective return paths is formed with a tapered surface, so as to prevent the rollers from impacting the entrance and exit of the grooves of the slide block, and prevent the rollers from tilting and being jammed, so that the rollers can circulate smoothly. Further, the slide block of the present invention doesn't need any extra chamfer, and thus the production cost is reduced.

While we have shown and described various embodiments in accordance with the present invention, it is clear to those skilled in the art that further embodiments may be made without departing from the scope of the present invention.

What is claimed is:

1. A roller circulating device for a linear guideway being formed with a plurality of grooves for enabling a plurality of rollers to circulate therein, each of the grooves including a forward path, a backward path, and two return paths, two ends of one of the returns path being connected to the forward path and one end of the backward path, respectively, and two ends of another one of the return paths being connected to the forward path and the other end of the backward path; characterized in that:
the respective return paths are connected to the forward path through at least one tapered surface; along a direction of a radial surface of the respective rollers, the tapered surface is tapered from the respective return paths to the forward path.

2. A roller circulating device for a linear guideway being formed with a plurality of grooves provided for enabling a plurality of rollers to circulate therein, each of the grooves including a forward path, a backward path, and two return paths, two ends of one of the returns path being connected to the forward path and one end of the backward path, respectively, and two ends of another one of the return paths being connected to the forward path and the other end of the backward path; characterized in that:
the respective return paths are connected to the forward path through at least one tapered surface; along a direction of an axial surface of the respective rollers, the tapered surface is tapered from the respective return paths to the forward path.

3. The roller circulating device for a linear guideway as claimed in claim 1, wherein each connecting portion between the forward path and the respective return paths is formed with a tapered surface being located along a direction of the axial surface of the respective rollers, the tapered surface is tapered from the respective return paths to the forward path.

4. The roller circulating device for a linear guideway as claimed in claim 1, wherein a width of the tapered surface on the return paths is larger than or equal to a width of the tapered surface on the forward path, and the width of the tapered surface on the return paths is less than a width of the tapered surface on the backward path.

5. The roller circulating device for a linear guideway as claimed in claim 2, wherein a width of the tapered surface on the return paths is larger than or equal to a width of the tapered surface on the forward path, and the width of the tapered surface on the return paths is less than a width of the tapered surface on the backward path.

6. The roller circulating device for a linear guideway as claimed in claim 2, wherein a radial width and an axial width of the tapered surface on the return paths are larger than or equal to a radial width and an axial width of the tapered surface on the forward path, and the radial width and the axial width of the tapered surface on the return paths are less than a radial width and an axial width of the tapered surface on the backward path.
